(19) United States
(12) Patent Application Publication
(10) Pub. No.: US 2014/0157297 A1
(43) Pub. Date: Jun. 5, 2014

(54) Marketing Method and Computer System thereof for Cloud System

(71) Applicant: WISTRON CORPORATION, New Taipei City (TW)

(72) Inventors: Ko-Li Chao, New Taipei City (TW); Tsung-Liang Lin, New Taipei City (TW); Bee Chien Jenny Chew, New Taipei City (TW); Ming-Hung Cheng, New Taipei City (TW); Kai-Hsien Yang, New Taipei City (TW); Ding-Teng Shih, New Taipei City (TW)

(73) Assignee: WISTRON CORPORATION, New Taipei City (TW)

(21) Appl. No.: 13/776,721

(22) Filed: Feb. 26, 2013

(30) Foreign Application Priority Data
Dec. 5, 2012 (TW) 101145677

(51) Int. Cl. G06Q 30/02

(52) U.S. Cl. CPC G06Q 30/0201
USPC 725/14

(57) ABSTRACT

A marketing method for combining a plurality of marketing information and a cloud system including a display device, a network server and a mobile device is disclosed. The marketing method includes obtaining a recognition information corresponding to at least a marketing information to process a video information to be a processed video information, installing an application software in the mobile device, displaying the processed video information on the display device, utilizing the application software and a detection module of the mobile device to obtain the recognition information while displaying the processed video information, and utilizing the network server to obtain a search result corresponding to the marketing information according to the recognition information.

### BACKGROUND OF THE INVENTION

1. Field of the Invention

The present invention relates to a marketing method and a computer system thereof for a cloud system, and more particularly, to a marketing method and a computer system thereof for a cloud system which obtain a processed video information corresponding to a marketing information via a mobile device.

2. Description of the Prior Art

As technology advances, digital products and computer systems equipped with various functions have become necessary in people's daily lives. Under such circumstances, daily consumption of normal people has changed from the practical window shopping mode to the virtual on-line shopping mode. Accordingly, the conventional marketing strategies have changed from practical handbills and billboards to virtual software applications and social networks via mobile devices in order to pursue more attention from consumers. Noticeably, the conventional advertisements are universally exposed to everyone via all kinds of mobile devices as well as the media, and the consumers have no choice but to passively receive the advertisements from promoters or sponsors rather than actively select the advertisements the consumers are interested in. Conventional marketing strategies/ways for promoting products are limited by timing/space of the market, and have much room for improvement.

Thus, it is important to provide another efficient marketing method and computer system thereof which adaptively provide proper commercials to the target consumers rather than passive/one-way promotion from product suppliers.

### SUMMARY OF THE INVENTION

It is therefore an objective of the invention to provide a marketing method and a computer system thereof for a cloud system which obtain a processed video information corresponding to a marketing information via a mobile device.

An embodiment of the invention discloses a marketing method for combining a plurality of marketing information and a cloud system comprising a display device, a network server and a mobile device. The marketing method comprises obtaining a recognition information corresponding to at least a marketing information to process a video information to be a processed video information, installing an application software in the mobile device, displaying the processed video information on the display device, utilizing the application software and a detection module of the mobile device to obtain the recognition information while displaying the processed video information, and utilizing the network server to obtain a search result corresponding to the marketing information according to the recognition information.

An embodiment of the invention also discloses another computer system coupled to a cloud system comprising a display device, a network server and a mobile device. The computer system comprises a central processing unit, a storage device coupled to the central processing unit for storing a programming code, and the programming code is utilized to instruct the central processing unit to process a marketing method for combining a plurality of marketing information and the cloud system. The marketing method comprises obtaining a recognition information corresponding to at least a marketing information to process a video information to be a processed video information, installing an application software in the mobile device, displaying the processed video information on the display device, utilizing the application software and a detection module of the mobile device to obtain the recognition information while displaying the processed video information, and utilizing the network server to obtain a search result corresponding to the marketing information according to the recognition information.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a computer system according to an embodiment of the invention.

FIG. 2A to FIG. 2C illustrate schematic diagrams of formation processes of the processed video information according to an embodiment of the invention.

FIG. 3 illustrates a schematic diagram of another processed video information according to an embodiment of the invention.

FIG. 4 illustrates a schematic diagram of another cloud system according to an embodiment of the invention.

FIG. 5 illustrates a flow chart of a marketing process according to an embodiment of the invention.

### DETAILED DESCRIPTION

The specification and the claim of the present invention may use a particular word to indicate an element, which may have diversified names named by distinct manufacturers. The present invention distinguishes the element depending on its function rather than its name. The phrase “comprising” used in the specification and the claim is to mean “is inclusive or open-ended but not exclude additional, un-recited elements or method steps.” In addition, the phrase “electrically connected to” or “coupled” is to mean any electrical connection in a direct manner or an indirect manner. Therefore, the description of “a first device electrically connected or coupled to a second device” is to mean that the first device is connected to the second device directly or by means of connecting through other devices or methods in an indirect manner.

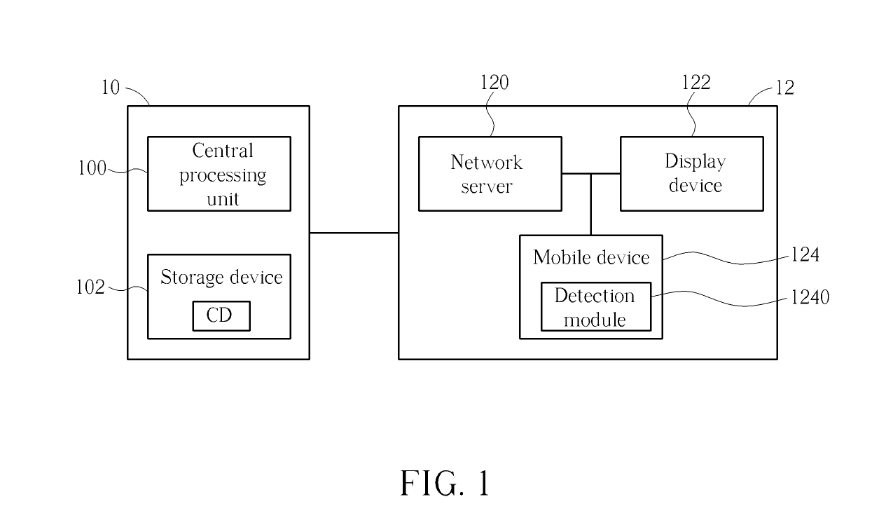

Please refer to FIG. 1, which illustrates a schematic diagram of a computer system 10 according to an embodiment of the invention. The computer system 10 is coupled to a cloud system 12, and comprises a central processing unit 100 and a storage device 102. The storage device 102 stores a programming code CD, and the programming code CD is utilized for instructing a marketing method for combining a plurality of marketing information and the cloud system 12. The computer system 10 and the cloud system 12 utilize a wired/wireless communication way to process signal communication. The cloud system 12 comprises a network server 120, a display device 122 and a mobile device 124. Preferably, the network server 120 is utilized for receiving at least a processed video information (not shown in the figure) comprising the plurality of marketing information, and the network server 120 and the display device 122 utilize the wired/wireless communication way to process signal communication as well, such that the network server 120 transmits the processed video information to the display device 122 for processing a display operation. The mobile device 124 and the network server 120 (or the display device 122) utilize another wireless communication way to process signal communication, which is not intended to limit the scope of the invention.

For the processed video information, a product supplier (not shown in the figure) may combine at least a marketing information with a video information to form the processed video information, so as to process a marketing operation for a promotional product. The video information and the processed video information comprises a plurality of frame signals, and each of the plurality of frame signals is realized via a scene as well as a subject (i.e. a person) or an objective. In the embodiment, the video information is a commercial video, and the marketing information is the promotional product promoted in the commercial video, such as sunglasses or suntan lotion. Certainly, the marketing information can also be a geographic information, a personal information or a business information in the commercial video, i.e. all the objects which can be sold/promoted by the product supplier are also in the scope of the invention.

Simply, after the cloud system 12 obtains the processed video information, the display device 122 will display the processed video information. Accordingly, a user (not shown in the figure) will operate a detection module 1240 of the mobile device 124 to retrieve at least one marketing information of the processed video information. Lastly, the mobile device 124 retransmits the marketing information to the network server 120 to correspondingly obtain a search result of the marketing information, such that the product supplier finishes the promotional operation for the user.

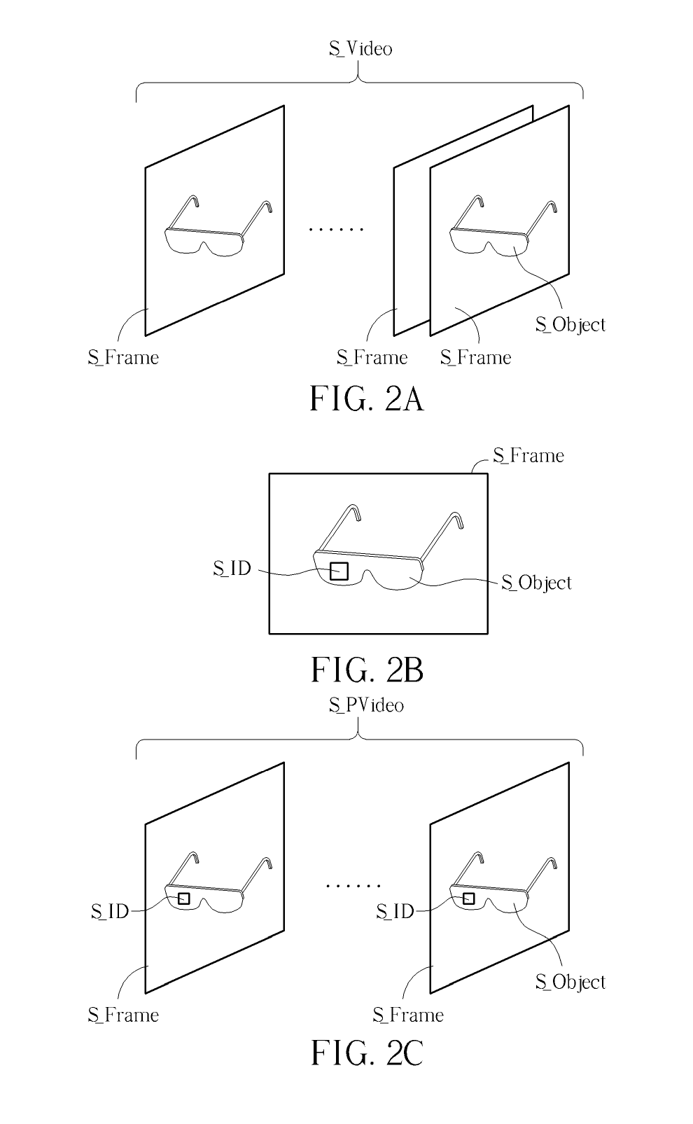

Preferably, the embodiment of the invention does not limit a combination way of the video information and the marketing information, and there are two combination ways provided herein. Please refer to FIG. 2A to FIG. 2C, which illustrate schematic diagrams of formation processes of the processed video information S_PVideo according to an embodiment of the invention. Specifically, FIG. 2A shows the video information S_Video of the invention, FIG. 2B shows that one frame signal S_Frame of the video information S_Video is selected, and accordingly, one marketing information S_Object (such as the sunglasses) of the frame signal S_Frame is selected. Next, a recognition information S_ID can be combined with the frame signal S_Frame to correspond to the marketing information S_Object, such that all the frame signals S_Frame are processed with the same combination. Lastly, FIG. 2C shows the processed video information S_PVideo according to an embodiment of the invention, wherein the marketing information S_Object can be directly showed on the processed video information S_PVideo or be hidden on the processed video information S_PVideo to prevent the user from distractedly observing the processed video information S_PVideo. The recognition information S_ID can be an optical recognition information (such as a QR code), an audio recognition information, a radio frequency recognition information or a geographic recognition information, which is not intended to limit the scope of the invention. Accordingly, based on the types of the recognition information S_ID, the detection module 1240 can be an optical recognition module, an audio recognition module, a radio frequency recognition module or a geographic recognition module, such that the detection module 1240 can adaptively recognize the recognition information S_ID to obtain the marketing information S_Object corresponding to the recognition information S_ID. Preferably, all the frame signals S_Frame shown from FIG. 2A to FIG. 2C have the recognition information S_ID overlapped on the marketing information S_Object, such that the user will have a responsive timing after observing the marketing information S_Object. Certainly, those skilled in the art can adaptively adjust one or a few of frame signals S_Frame to comprise the recognition information S_ID, or a position of the recognition information S_ID can be changed to be close to the marketing information S_Object instead of overlapping with the marketing information S_Object. Additionally, a plurality of frame signals S_Frame can be interlaced for combining different recognition information S_ID, and one or many of frame signals S_Frame can simultaneously comprise a plurality of marketing information S_Object (such as sunglasses and suntan lotion) as well as a plurality of recognition information S_ID thereof. Thus, the product supplier can process the promotional operation for the plurality of marketing information S_Object, and accordingly, the user can adaptively select at least one interested marketing information S_Object, which is also in the scope of the invention.

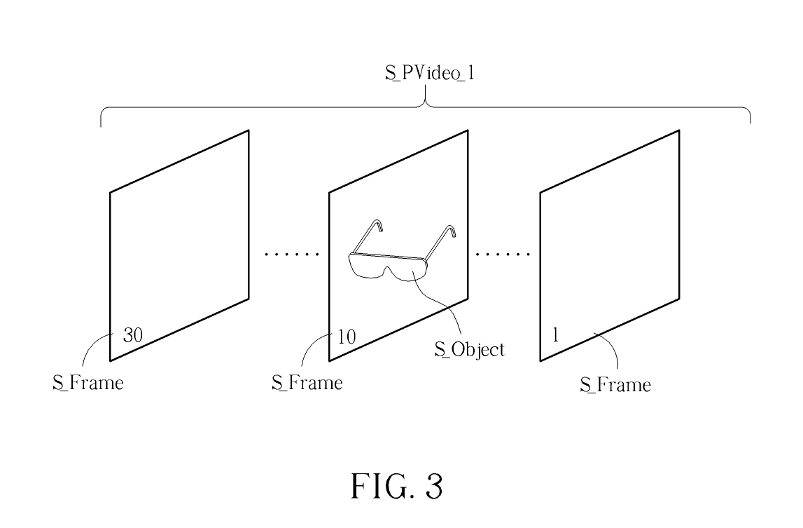

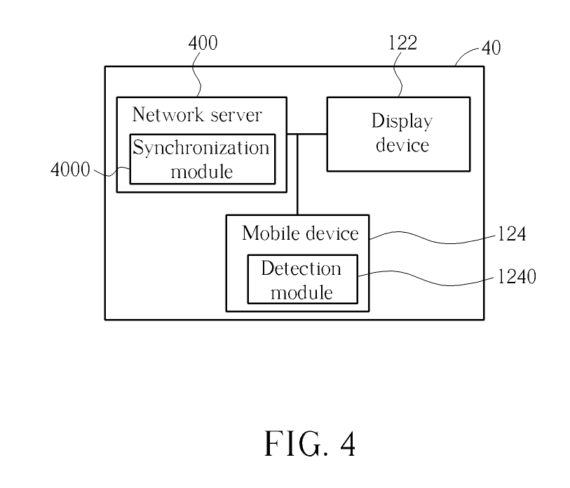

Please refer to FIG. 3, which illustrates a schematic diagram of another processed video information S_PVideo_1 according to an embodiment of the invention. In comparison with the embodiment shown in FIG. 2A to FIG. 2C, the processed video information S_PVideo_1, as shown in FIG. 3, does not directly overlap the recognition information S_ID on the marketing information S_Object. Instead, the product supplier pre-processes the video information S_Video to comprise the marketing information S_Object interested by the user, and a plurality of the frame signals S_Frame of the video information S_Video are numbered to form the processed video information S_PVideo_1. For example, the frame signal S_Frame numbered with 10 comprises the marketing information S_Object, and the frame signals S_Frame numbered with 1-9 and 11-30 do not comprise the marketing information S_Object. Please refer to FIG. 4, which illustrates a schematic diagram of another cloud system 40 according to an embodiment of the invention. As shown in FIG. 4, the cloud system 40 further comprises a synchronization module 4000 in the network server 400 in comparison with the cloud system 12 shown in FIG. 1. Under such circumstances, when the processed video information S_PVideo_1 shown in FIG. 3 is displayed, the network server 400, the mobile device 124 and the display device 122 are synchronized. Accordingly, after the synchronization, the user can utilize the detection module 1240 of the mobile device 124 (such as the optical recognition module) to determine whether an interested marketing information S_Object is displayed on the display device 122, so as to inform the network server 400 whether the processed video information S_PVideo_1 comprises the interested marketing information S_Object therein. Certainly, cooperating with the responsive timing of the user, the embodiment of the invention can also be utilized to determine whether a plurality of frame signals S_Frame simultaneously comprise the same marketing information S_Object, so as to prevent the user from accidentally missing any scenes/pictures of the processed video information S_PVideo, which is also in the scope of the invention.

In other words, the invention provides two solutions for forming the processed video information. If the processed comprises the recognition information, the mobile device directly utilizes the detection module to recognize whether the recognition information exists. If the processed video information does not comprise the recognition information and is sequentially numbered according to the recognition information, the mobile device, the display device and the network server will be initially synchronized and the detection module of the mobile device will be utilized to recognize the marketing information for obtaining at least one of the marketing information interested by the user from the video information.

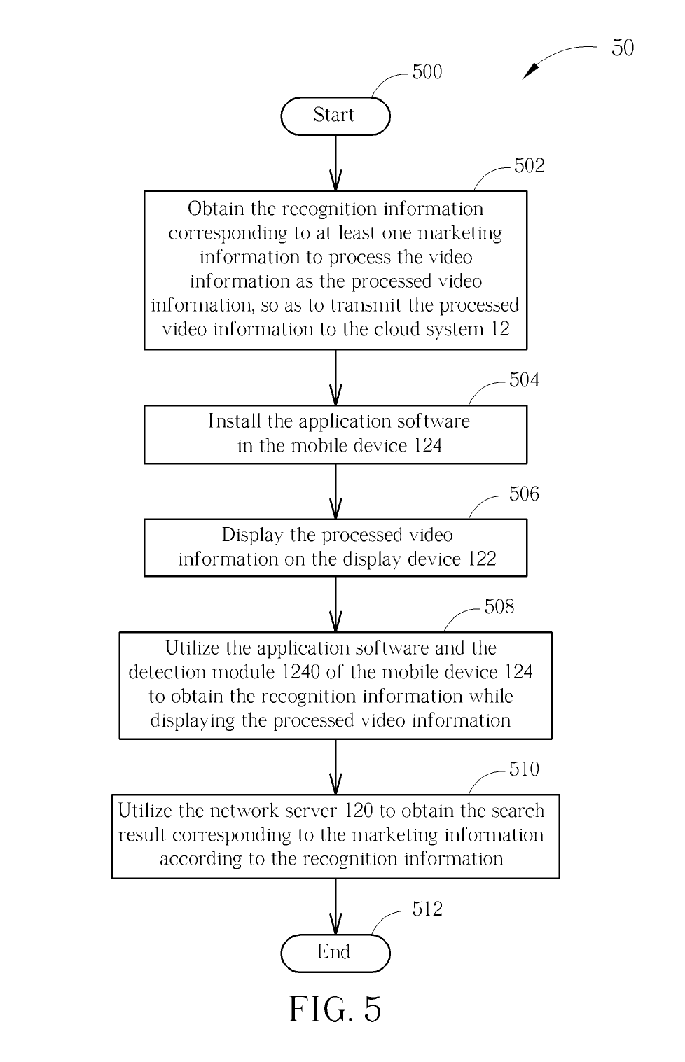

Further, the embodiments of the invention provide a marketing method for the computer system 10 to control the cloud system 12 and 40, and the marketing method can be summarized as a marketing process 50 to be compiled as the programming code CD, as shown in FIG. 5. The marketing process 50 includes the following steps.

Step 500: Start.

Step 502: Obtain the recognition information corresponding to at least one marketing information to process the video information as the processed video information, so as to transmit the processed video information to the cloud system 12.

Step 504: Install the application software in the mobile device 124.

Step 506: Display the processed video information on the display device 122.

Step 508: Utilize the application software and the detection module 1240 of the mobile device 124 to obtain the recognition information while displaying the processed video information.

Step 510: Utilize the network server 120 to obtain the search result corresponding to the marketing information according to the recognition information.

Step 512: End.

In step 502, the product supplier adaptively modifies/combines the recognition information and the video information according to the embodiments shown in FIG. 2A to FIG. 4, or processes the number operation of the frame signals to obtain the processed video information, so as to transmit the processed video information to the network server 120 of the cloud system 12.

In step 504, the user utilizes the mobile device 124 to access the Internet for obtaining the application software from a network software store provided by the product supplier, so as to install the application software in the mobile device 124, wherein the application software comprises a function for recognizing the recognition information as well as synchronizing the network server 120. Besides, the embodiment of the invention is not limiting the realization of the application software, and the application software can be designed with a user interface and at least one virtual button, such that the detection module 1240 of the mobile device 124 can be initiated via pressing the virtual button, which is not intended to limit the scope of the invention.

In step 506, the network server 120 transmits the processed video information to the display device 122 for displaying according to a scheduled information. Preferably, the scheduled information comprises a scheduled timing information and a scheduled location information, such that the processed video information is displayed on one or more display devices 122 at a plurality of scheduled timings as well as at a plurality of scheduled locations according to different requirements of the product supplier. Certainly, the displaying way of the processed video information on the display device 122 can be adaptively modified to comply with hardware requirements of billboards or TV walls, which is also in the scope of the invention. Moreover, the computer system 10 further comprises another user interface to provide adjustments of the scheduled timing information and the scheduled location information, so as to cooperate with different promotional operations of the promoted products, such as displaying in public, through the Internet or in general TV broadcasting shows.

In step 508, when the user displays the processed video information, he will actively receive the processed video information as well as at least one marketing information thereof. Under such circumstances, while the user observes the interested marketing information, he will correspondingly initiate the application software and the detection module 1240, such as processing a touch operation to press the virtual button of the user interface to initiate the optical recognition module, for obtaining the recognition information corresponding to the marketing information from the plurality of frame signals of the processed video information. Besides, the application software can be designed to utilize a position change operation of the mobile device 124, such as shaking the mobile device 124, to correspondingly initiate the optical recognition module for retrieving the recognition information. Also, the detection module 1240 can simultaneously retrieve a plurality of recognition information corresponding to the plurality of marketing information from one or more frame signals via the touch operation or the position change operation of the application software, which is also in the scope of the invention.

In step 510, after obtaining at least one recognition information, the mobile device 124 utilizes a wireless transmission to transmit at least one recognition information to the network server 120. Accordingly, the network server 120 can be informed of the at least one interested marketing information of the user. In the embodiment, the network server 120 further connects to the Internet and a processing unit (not shown in the figure), and a search function of the Internet can also be utilized to provide a corresponding search result of the marketing information, wherein the processing unit comprises a detailed list information of the promoted products from the product supplier. For example, if the user is interested in sunglasses and correspondingly retrieves the recognition information thereof, the network server 120 will transmit the recognition information as well as the video information to the processing unit. Next, the processing unit will process an analysis operation between the recognition information and the video information, and related information of brands as well as types corresponding to the sunglasses can be retrieved from the detailed list information. In combination with the search function of the Internet, prices as well as types of the sunglasses are obtained to be transmitted to the user through the mobile device 124. Under such circumstances, the user does not need to predict/guess the brand or the product number of the sunglasses in advance, and has no need to process the search operation via the Internet, so as to prevent a recognition error of the promoted product and fail to obtain the correct search result of the promoted product.

Noticeably, according to different promoted products, the product supplier will utilize different promotional operations. For example, the video information can further comprise unrelated information of the promoted products, such as a geographic information, a personal information or a business information. After the user obtains the interested marketing information as well as the search result thereof, the processing unit can also provide the geographic information, the personal information or the business information having a higher dependency as the search result to the user. For example, a landscape location, a personal introduction of a super star, a business promotion activity or a coupon can be combined with the search result to be provided to the user as well. Certainly, the processing unit further comprises a storage unit (not shown in the figure), and after each user obtains his/her search result of the promoted product, a user data base for recording different users' habits as well as personal interests is set up to comprise a plurality of user information as well as a plurality of marketing information, such that the product supplier can directly utilize the user data base to obtain a market response result corresponding to each of the plurality of marketing information. Accordingly, different promotional operations are arranged according to the market response result, and the Data Mining and the Big Data Analysis can also be processed, which is not intended to limit the scope of the invention.

Furthermore, in the embodiment, the marketing information is not limited by the promotional operation provided from the product supplier, and contents of the promotional information as well as the video information are not restricted within the commercial activities only. In other words, the cloud system of the invention can be extended over the idea of single mobile device, such that those skilled in the art can utilize the concept of the invention to be applied to a plurality of network servers for sharing information between different users, so as to build up a discussion zone/forum or a social website on the Internet. Also, via different wide area networks (WANs), governments or companies can utilize the same concept of the invention for data statistics and employers therein can update their reports as well, which is also in the scope of the invention.

In summary, the embodiments of the invention provide a marketing method for combining a plurality of marketing information as well as a cloud system, which obtain a recognition information on a display device and correspondingly obtain a search result of a promoted product by a network server. Thus, manual operations or search operations through the Internet of the user can be significantly reduced, and the product supplier can adaptively provide the proper marketing information to satisfy different consumers, so as to increase an exposed market rate of promoted products. Also, the consumers can precisely receive the promoted product of their interests to improve efficiency of promotion as well as to lower the marketing costs thereof.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A marketing method for combining a plurality of marketing information and a cloud system comprising a display device, a network server and a mobile device, the marketing method comprising:
obtaining a recognition information corresponding to at least a marketing information to process a video information to be a processed video information;
installing an application software in the mobile device;
displaying the processed video information on the display device;
utilizing the application software and a detection module of the mobile device to obtain the recognition information while displaying the processed video information; and
utilizing the network server to obtain a search result corresponding to the marketing information according to the recognition information.

2. The marketing method of claim 1, wherein the step of obtaining the recognition information corresponding to at least the marketing information to process the video information to be the processed video information comprises:
selecting one of a plurality of frame signals corresponding to the video information to combine the at least one recognition information and the one of the plurality of frame signals, so as to obtain the processed video information.

3. The marketing method of claim 2, wherein the recognition information is realized as an optical recognition information, an audio recognition information, a radio frequency recognition information or a geographic recognition information.

4. The marketing method of claim 3, wherein the detection module is realized as an optical recognition module, an audio recognition module, a radio frequency recognition module or a geographic recognition module.

5. The marketing method of claim 1, wherein the step of obtaining the recognition information corresponding to at least the marketing information to process the video information to be the processed video information comprises:
numbering a plurality of frame signals corresponding to the video information according to the recognition information, to form the processed video information.

6. The marketing method of claim 5, further comprising utilizing a synchronization module to synchronize the mobile device, the network server and the display device while displaying the processed video information.

7. The marketing method of claim 6, wherein the detection module is an optical recognition module to retrieve the plurality of frame signals of the processed video information while the mobile device, the network server and the display device are synchronizing.

8. The marketing method of claim 1, wherein the step of installing the application software in the mobile device comprises:
synchronizing the mobile device and the display device.

9. The marketing method of claim 1, wherein the step of displaying the processed video information on the display device comprises :
displaying the processed video information on the display device according to a scheduled information.

10. The marketing method of claim 9, wherein the scheduled information comprises a scheduled timing information and a scheduled location information, such that the processed video information is displayed on a plurality of scheduled timings as well as at a plurality of scheduled locations.

11. The marketing method of claim 1, wherein the step of utilizing the application software and the detection module of the mobile device to obtain the recognition information while displaying the processed video information comprises:
processing a touch operation or a position change operation of the mobile device to drive the detection module for retrieving the recognition information.

12. The marketing method of claim 11, wherein the step of utilizing the application software and the detection module of the mobile device to obtain the recognition information while displaying the processed video information comprises:
simultaneously obtaining a plurality of recognition information.

13. The marketing method of claim 1, further comprising setting up a user data base according to the search result, to correspondingly obtain a market response result of the marketing information.

14. The marketing method of claim 13, wherein the search result is provided to another computer system, another display device or another network server coupled to the cloud system, to access the user data base or the market response result.

15. A computer system coupled to a cloud system comprising a display device, a network server and a mobile device, the computer system comprising:
a central processing unit;
a storage device coupled to the central processing unit for storing a programming code, and the programming code is utilized to instruct the central processing unit to process a marketing method for combining a plurality of marketing information and the cloud system, the marketing method comprising:
obtaining a recognition information corresponding to at least a marketing information to process a video information to be a processed video information;
installing an application software in the mobile device;
displaying the processed video information on the display device;
utilizing the application software and a detection module of the mobile device to obtain the recognition information while displaying the processed video information; and
utilizing the network server to obtain a search result corresponding to the marketing information according to the recognition information.

16. The computer system of claim 15, wherein the step of obtaining the recognition information corresponding to at least the marketing information to process the video information to be the processed video information comprises:
selecting one of a plurality of frame signals corresponding to the video information to combine the at least one recognition information and the one of the plurality of frame signals, so as to obtain the processed video information.

17. The computer system of claim 16, wherein the recognition information is realized as an optical recognition information, an audio recognition information, a radio frequency recognition information or a geographic recognition information.

18. The computer system of claim 17, wherein the detection module is realized as an optical recognition module, an audio recognition module, a radio frequency recognition module or a geographic recognition module.

19. The computer system of claim 15, wherein the step of obtaining the recognition information corresponding to at least the marketing information to process the video information to be the processed video information comprises:
numbering a plurality of frame signals corresponding to the video information according to the recognition information, to form the processed video information.

20. The computer system of claim 19, further comprising a synchronization module for synchronizing the mobile device, the network server and the display device while displaying the processed video information.

21. The computer system of claim 20, wherein the detection module is an optical recognition module to retrieve the plurality of frame signals of the processed video information while the mobile device, the network server and the display device are synchronizing.

22. The computer system of claim 15, wherein the step of installing the application software in the mobile device comprises:
synchronizing the mobile device and the display device.

23. The computer system of claim 15, wherein the step of displaying the processed video information on the display device comprises:
displaying the processed video information on the display device according to a scheduled information.

24. The computer system of claim 23, wherein the scheduled information comprises a scheduled timing information and a scheduled location information, such that the processed video information is displayed via a display operation on a plurality of scheduled timings as well as at a plurality of scheduled locations, and the display operation comprises a group operation, an individual operation and a synchronization operation.

25. The computer system of claim 15, wherein the step of utilizing the application software and the detection module of the mobile device to obtain the recognition information while displaying the processed video information comprises:
processing a touch operation or a position change operation of the mobile device to drive the detection module for retrieving the recognition information.

26. The computer system of claim 25, wherein the step of utilizing the application software and the detection module of the mobile device to obtain the recognition information while displaying the processed video information comprises:
simultaneously obtaining a plurality of recognition information.

27. The computer system of claim 15, the marketing method further comprises setting up a user data base according to the search result, to correspondingly obtain a market response result of the marketing information.

28. The computer system of claim 27, wherein the search result is provided to another computer system, another display device or another network server coupled to the cloud system, to access the user data base or the market response result.
